(19) United States
(12) Patent Application Publication
(10) Pub. No.: US 2020/0068790 A1
(43) Pub. Date: Mar. 5, 2020

(54) NOZZLE AND HOUSING FOR INPUTS IN AGRICULTURAL IMPLEMENTS

(71) Applicant: Jose Roberto do Amaral Assy, Caldas Novas (BR)

(72) Inventors: Jose Roberto do Amaral Assy, Caldas Novas (BR); Claudio Chiba Kawasaki, Sao Paulo (BR); Antonio Miguel Hernandez Gonzales Gomez, Sao Paulo (BR)

(21) Appl. No.: 16/559,879

(22) Filed: Sep. 4, 2019

(30) Foreign Application Priority Data
Sep. 4, 2018 (BR) 10 2018 067826 4

(51) Int. Cl. A01C 7/20

(52) U.S. Cl. CPC A01C 7/201; A01C 7/06; A01C 7/206

(57) ABSTRACT

Agricultural implement nozzle assemblies of the present disclosure may include a meter input housing, a locking tab, and a tubular nozzle. The meter input housing may include a tubular opening. The locking tab may protrude from a peripheral region of the tubular opening. The tubular nozzle may include a locking mechanism complementary to the locking tab protruding from the peripheral region of the tubular opening. The nozzle may be rotatable relative to the tubular opening when the nozzle is coupled to the meter input housing via the locking mechanism and the locking tab. Related agricultural implement input assemblies are also disclosed.

### CROSS REFERENCE TO RELATED APPLICATION

This application claims the benefit of Brazilian Patent Application No. BR 10 2018 067826 4, titled “BOCAL E ALOJAMENTO DE INSUMOS DE IMPLEMENTO AGRICOLA,” filed 4 Sep. 2018, the disclosure of which is incorporated, in its entirety, by this reference.

### TECHNICAL FIELD

The present disclosure generally relates to the supply of inputs in agricultural equipment. For example, the present disclosure relates to the coupling of agricultural input devices and the housing of these inputs, to be metered in agricultural implements.

### BACKGROUND

Agriculture is a productive activity of great importance for the livelihood and development of the world population. In order to obtain large yields and, consequently, ensure greater profits to farmers and to provide a greater availability of raw material to the market, technological applications are used in agricultural implements. Agricultural implements for planting, generally called planters or sowing machines, are widely known and are mainly used for planting in large fields.

One of the factors that contributes to the increase of agricultural production is the mechanization of seed metering. Mechanized metering generally uses some common elements, namely planting rows, seed boxes, hoses, and meters.

Seed boxes are usually selected according to the volume of seeds needed to meet the required planting area so that it is not necessary to stop the farm implement to replenish. The most commonly used types are individual boxes and central boxes.

Individual boxes are often cheaper and widely used in smaller farm implements. The individual boxes are mounted directly on the meters. Usually, the walls of the individual boxes are overlapped on the outside walls of the meters for drilling with a drill or other equipment and fixed by screws, washers, and nuts.

Due to the need to drill holes, as well as spending a great deal of time on assembly and relying on specific tools, the individual boxes are subject to positioning errors on the meters during drilling. In the event of a wrong drilling, the fixation may be weakened and seed leaks may occur.

Although individual boxes are functional, it may be difficult for the farmer to supply individual boxes, as the meters are typically individually supplied and the seeds are carried in bags that can weigh more than 50 kg. Seed bags are usually hoisted with machines, and these machines are moved over each seed box during a supply operation.

Central seed boxes have a larger seed volume than a corresponding individual box. Central seed boxes receive all seeds in one place, and a single central seed box supplies several meters directly through hoses and using intermediate boxes, similar to individual boxes. Thus, the use of central box can facilitate the filling process and save time that would be spent moving machines to drive the seeds along the planting rows.

Central seed boxes are able to carry much larger amounts of seed and are fixed to the planter chassis frame so that they are raised along with the planter chassis frame during periods when no planting is taking place, such as during maneuvering or transport to a planter parking area.

During planting, the central seed boxes are conventionally lowered together with the planter chassis frame. During this operation, a known problem may occur with the central seed boxes when hoses, which connect the central seed box to the meter, form folds. This problem is sometimes known as “choke.” The direct consequences of these folding events are the clogging of the hoses, so that the seeds do not reach (or fewer seeds reach) the meters and, thus, entire rows can be planted improperly (e.g., seedless) if the farmer does not have a crop failure detection system.

In order to avoid further damage, there are known systems that have intermediate boxes or larger reservoirs directly connected to the meters. Thus, clogging in a central seed box feed hose may not cause immediate damage, as seeds in the meter reservoir may be sufficient to travel a relatively satisfactory distance before having to stop the implement and raise the central box to stretch the hose and fill the meter reservoir.

Another known problem with traditional seed metering systems occurs during maintenance, where the hoses are rigidly fixed and make it difficult or impossible to open the meters. In these cases, it is often necessary to disassemble the whole assembly to check any internal problem or to perform component replacement.

In conventional systems, the clogging of the hose by bending or choking inhibits (e.g., prevents or restricts) the constant flow of seeds to the meter. This decreases the constant movement time during planting between stops to raise the central seed box and replenish the meter reservoirs.

Particularly in systems for distributing inputs with intermediate boxes over the meters, in a hose clogging event, the implement would still maintain the delivery of the supplies for a short time before becoming fully terminated. If the operator is not promptly alerted to the lack of inputs, major failures may occur at planting or, if the operator is alerted, the implement must be stopped to clear hoses and replenish the meters.

Generally, conventional systems are coupled to fixed and stationary docking points, which makes manufacturing, installation, and maintenance more complicated and time consuming and often requires disassembly of the entire assembly for a simple maintenance check or change.

Accordingly, the present disclosure recognizes some drawbacks and limitations related to installation, maintenance, and use of conventional agricultural implements.

### BRIEF SUMMARY

The present disclosure generally relates to an agricultural implement nozzle assembly. In some embodiments, the agricultural implement nozzle assembly may include a meter input housing including a tubular opening, a locking tab protruding from a peripheral region of the tubular opening, and a tubular nozzle including a locking mechanism complementary to the locking tab protruding from the peripheral region of the tubular opening. The nozzle may be rotatable relative to the tubular opening when the nozzle is coupled to the meter input housing via the locking mechanism and the locking tab.

In some examples, the locking tab may protrude inward in the tubular opening, and the locking mechanism may protrude outward from the nozzle. In additional examples, the locking tab may protrude outward from the tubular opening and the locking mechanism may protrude inward from the nozzle. A seal element may be positioned to inhibit unwanted material from entering the nozzle. The locking mechanism of the nozzle may be movable relative to a sidewall of the nozzle. The nozzle may be a split nozzle that includes a first portion and a second portion configured to be assembled to each other. A quick-fit mechanism may be configured to join the first portion and the second portion. In additional examples, the nozzle assembly may also include at least one screw to join the first portion to the second portion. At least the locking mechanism may include a resilient material that is configured to flex to snap-fit the nozzle to the tubular opening of the meter input housing. The nozzle may be fully rotatable with respect to the tubular opening. The meter input housing may include a reservoir for at least one of: seeds, fertilizer, graphite, or inoculant.

In some embodiments, the present disclosure may include an agricultrual implement input assembly, which may include an input meter, an input housing, and a coupling ring. The input meter may include an upper input receiving aperture. The input housing may be configured to be coupled to the input meter. The input housing may include a tubular opening for feeding an input into the input housing, an inspection opening covered by an inspection cap, and a lower coupling opening sized and shaped to direct the input into the upper input receiving aperture of the input meter. The coupling ring may be configured to couple the input housing to the input meter.

In some examples, the coupling ring may include at least one fastener for securing the coupling ring to the input meter. The at least one fastener may include at least one of: a movable lock, a quick coupler, or a screw fitting. In additional examples, the meter input housing may include a reservoir for seeds, fertilizer, graphite, or inoculant.

### BRIEF DESCRIPTION OF THE DRAWINGS

The accompanying drawings illustrate a number of example embodiments and are a part of the specification. Together with the following description, these drawings demonstrate and explain various principles, potential advantages, and potential technical and functional improvements of the present disclosure.

FIG. 1 shows a perspective view of a part of an agricultural implement with a raised central box for inputs, according to at least one embodiment of the present disclosure.

FIG. 2 shows a perspective view of a part of an agricultural implement with a lowered central box for inputs, according to at least one embodiment of the present disclosure.

FIG. 3 shows a top perspective view of a meter housing assembly with nozzle housing, according to at least one embodiment of the present disclosure.

FIG. 4 shows a bottom perspective view of the assembly of FIG. 3.

FIG. 5 shows a side view of the assembly of FIG. 3.

FIG. 6 shows an exploded perspective view of the assembly of FIG. 3.

FIG. 7 shows a sectional side view of an assembly, according to at least one embodiment of the present disclosure.

FIG. 8 shows a top perspective view of the assembly of FIG. 7.

FIG. 9 shows a bottom perspective view of the assembly of FIG. 7.

FIG. 10 shows a side view of a nozzle, according to at least one embodiment of the present disclosure.

FIG. 11 shows a top perspective view of the nozzle of FIG. 10.

FIG. 12 shows a bottom perspective view of the nozzle of FIG. 10.

FIG. 13 shows a side view of a nozzle, according to at least one additional embodiment of the present disclosure.

FIG. 14 shows a bottom perspective view of the nozzle of FIG. 13.

FIG. 15 shows a top perspective view of the nozzle of FIG. 13.

FIG. 16 shows a front view of a split nozzle in its joined condition, according to at least one embodiment of the present disclosure.

FIG. 17 shows a front view of the split nozzle in its separated condition, according to at least one embodiment of the present disclosure.

FIG. 18 shows a bottom perspective view of the split nozzle of FIG. 16.

FIG. 19 shows a top perspective view of the split nozzle of FIG. 16.

FIG. 20 shows a side left side view of the split nozzle of FIG. 16.

FIG. 21 shows a side view of the left inner portion of the split nozzle of FIG. 16.

FIG. 22 shows a top perspective view of the right portion of the split nozzle of FIG. 16.

FIG. 23 shows a bottom perspective view of the right portion of the split nozzle of FIG. 16.

FIG. 24 shows a top perspective view of the left portion of the split nozzle of FIG. 16.

FIG. 25 shows a bottom perspective view of the left portion of the split nozzle of FIG. 16.

FIG. 26 shows a partial cross-sectional side view of a nozzle assembly, according to at least one embodiment of the present disclosure.

Throughout the drawings, identical or similar reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to a nozzle system used in an agricultural implement that is capable of eliminating or at least reducing the limitations of known technologies. The present disclosure also includes a housing system, such as for use on farm implement meters, which may be capable of facilitating installation, maintenance, and use.

Embodiments of the present disclosure will now be described with reference to the accompanying figures. The figures are not necessarily drawn to scale; that is, certain features of the present disclosure may be shown to be exaggerated or in some schematic manner, and details of conventional elements may not be shown in order to illustrate certain embodiments more clearly and concisely. The present disclosure is susceptible to implementaion in different ways. Specific embodiments are described in detail and shown in the figures, with the understanding that the description should be considered as an exemplification of the principles disclosed herein. Thus, the present disclosure is not intended to be limited to what is illustrated and described in this specification. It should be recognized that the different particular elements of the embodiments discussed below may be employed separately or in any suitable combination to produce the same or similar technical effects.

The present disclosure will be described hereinafter using a planting row as a non-limiting form of an agricultural implement, within the understanding that principles of the present disclosure may be employed in other agricultural implements, such as fertilizers, sprayers, and other types of implements that use inputs.

In some examples, the terms “input” and “inputs” may refer to material to be metered in an agricultural implement. For example, inputs may include, among others, seeds, fertilizers, graphite, and an inoculant.

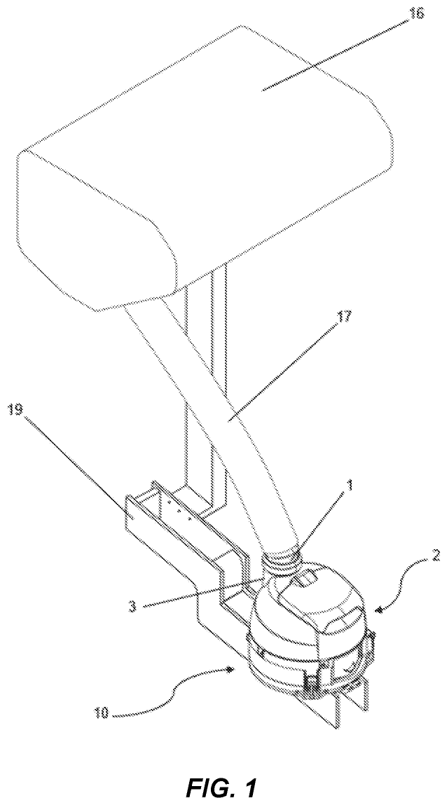

In some embodiments, as illustrated in FIG. 1, a meter 10 may be attached to a farm implement structure 19 and a meter input housing 2 may be mounted on the meter 10. The meter 10 may receive inputs (e.g., seeds, fertilizers, graphite, an inoculant, etc.) from a central box 16, which may be disposed at another end of the agricultural implement structure 19, through a hose 17 attached to a nozzle 1. The nozzle 1 may, in turn, be attached to a tubular opening 3 of the meter input housing 2.

Still referring to FIG. 1, the central box 16 is shown raised relative to the meter 10. In this configuration, the hose 17 may be substantially stretched, and the distance between the meter 10 and the central box 16 may be at its maximum.

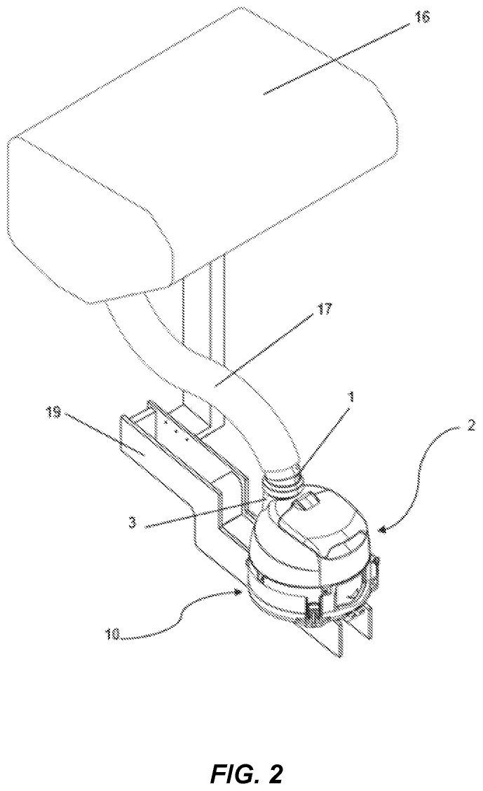

FIG. 2 shows the same elements as FIG. 1, but with the central box 16 in a lowered position. In this configuration, the distance between the meter 10 and the central box 16 is the smallest possible for the implement and curves in the hose 17. Although the hose 17 may bend when the central box 16 is lowered, the nozzle 1 to which the hose 17 is fixed may rotate freely relative to the tubular opening 3 of the meter input housing 2. This rotation may allow the lower portion of the hose 17 to move sideways rather than bend.

The assemblies of the present disclosure may inhibit (e.g., avoid or reduce) the formation of kinks in hoses 17, which may cause clogging of input material that is moving through the hoses 17. Thus, embodiments of the present disclosure may ensure that the input stream from the central box 16, also known as the single box, reaches the meter 10 constantly. Thus, as the seeds (or other inputs) leave the dispenser 10, the input column within the hose 17 may descend via gravity into the input housing 2, and the hose 17 may be fed upward and backward to the central housing 16.

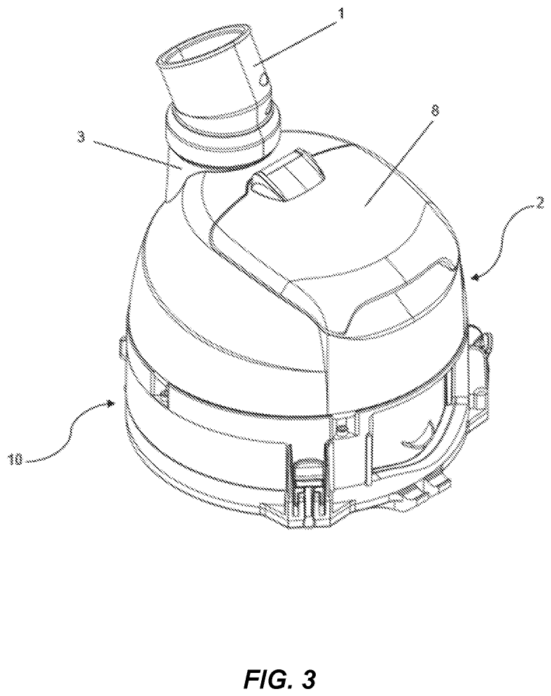

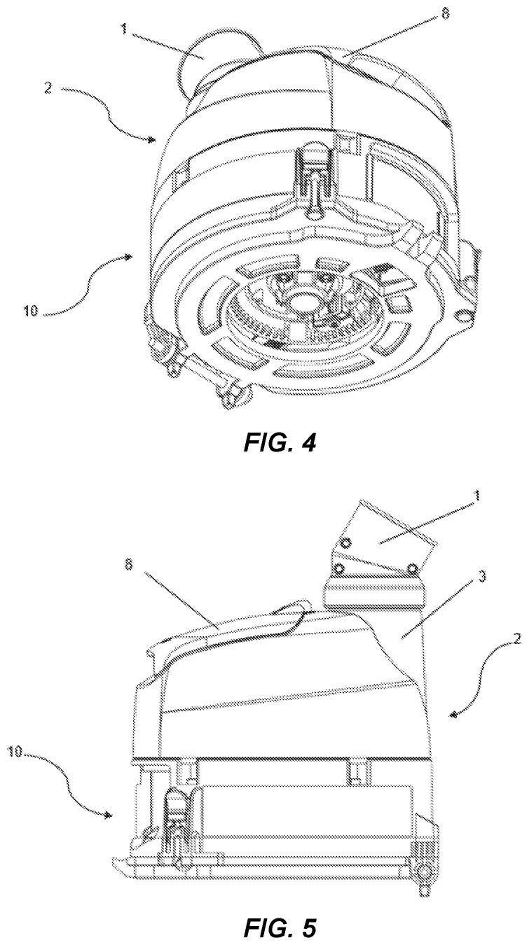

FIGS. 3, 4, and 5 illustrate an assembly, according to an embodiment of the present disclosure, wherein the meter input housing 2 is engaged with the meter 10 and the nozzle 1 is engaged with the tubular opening 3 of the meter input housing 2.

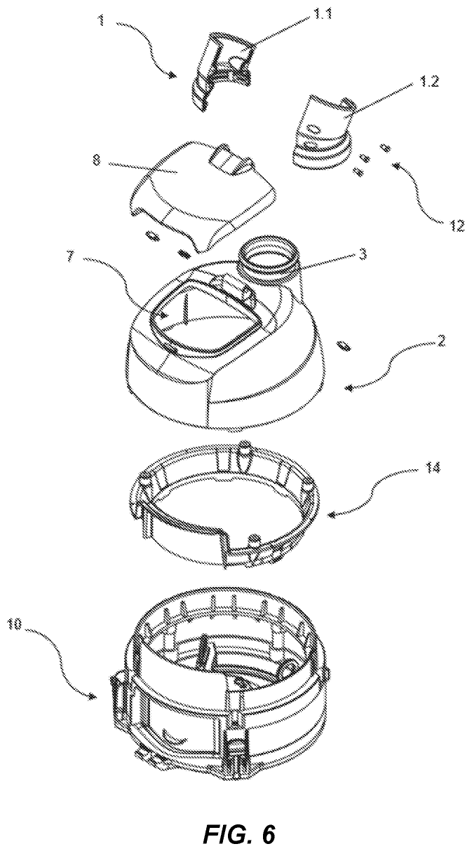

In addition, FIGS. 3, 4, and 5 also show an inspection cap 8. The inspection cap 8 may be hinged to the meter input housing 2 over an inspection opening 7 (shown in FIG. 6) of the meter input housing 2. The inspection opening may serve to enable a user to view the interior of the meter input housing 2 for any maintenance, such as changing the input meter 10 components or removing the inputs for sampling and cleaning.

FIG. 6 shows an exploded view of an assembly according to the present disclosure. The assembly may include, from the bottom up in the view of FIG. 6, an input meter 10, a coupling ring 14, an meter input housing 2, an inspection cap 8 and a first (e.g., right) portion 1.1 and a second (e.g., left) portion 1.2 of a split nozzle 1.

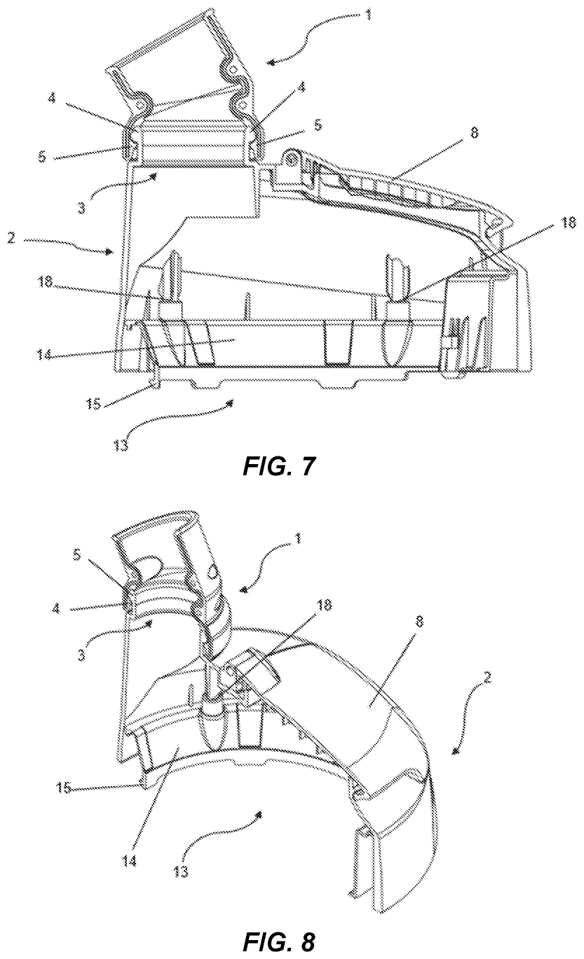

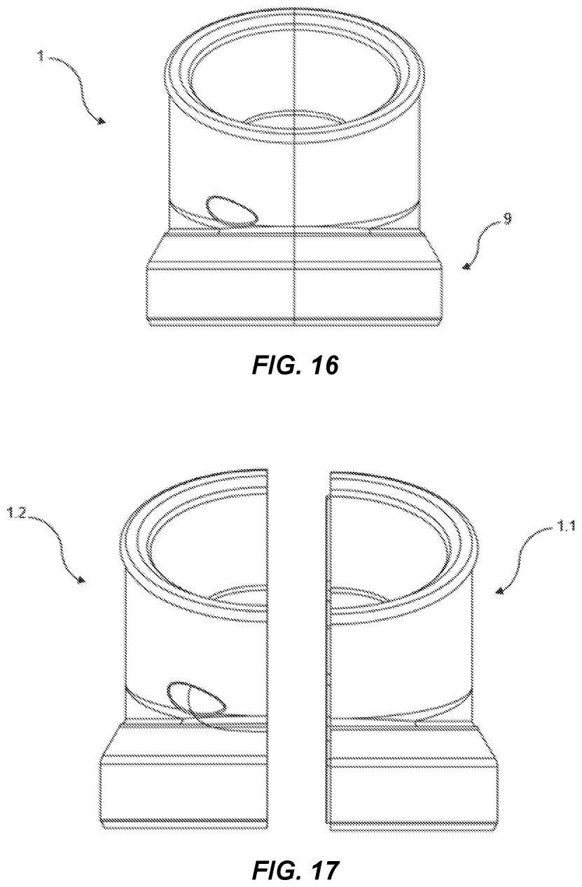

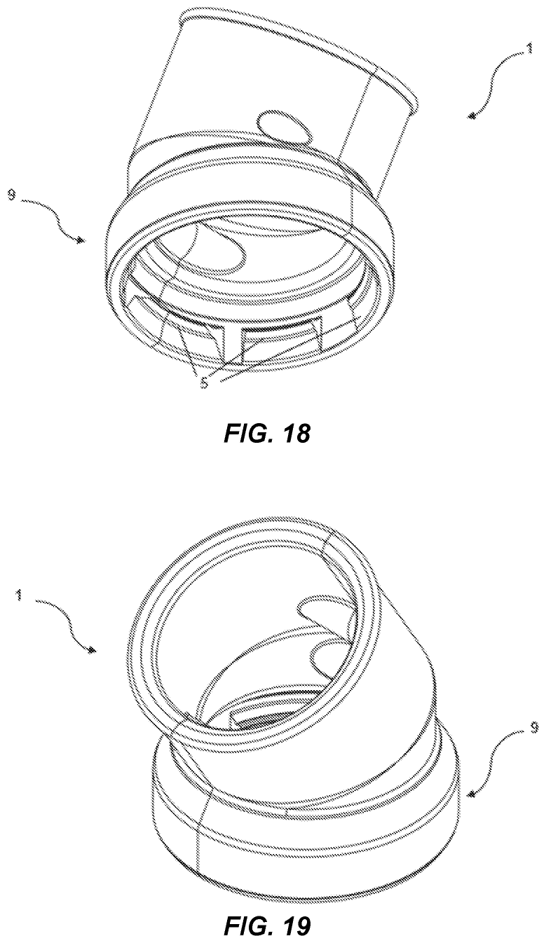

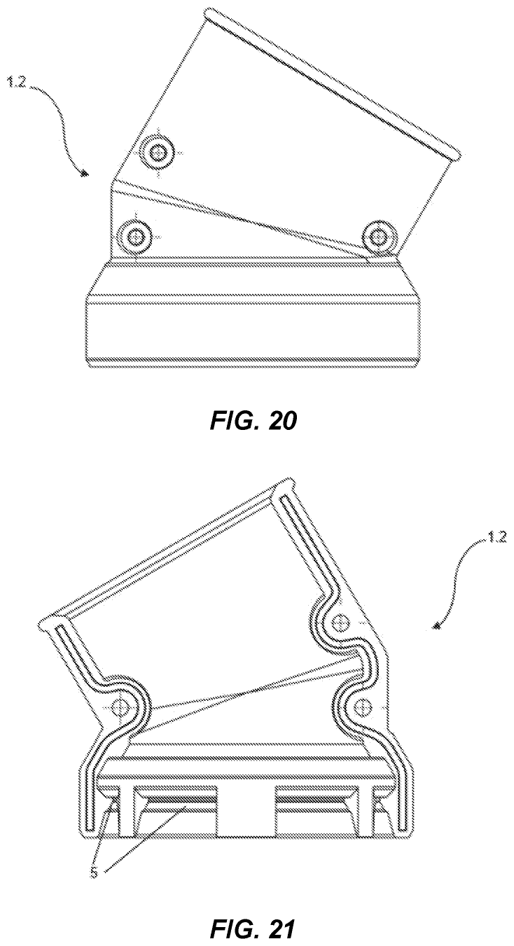

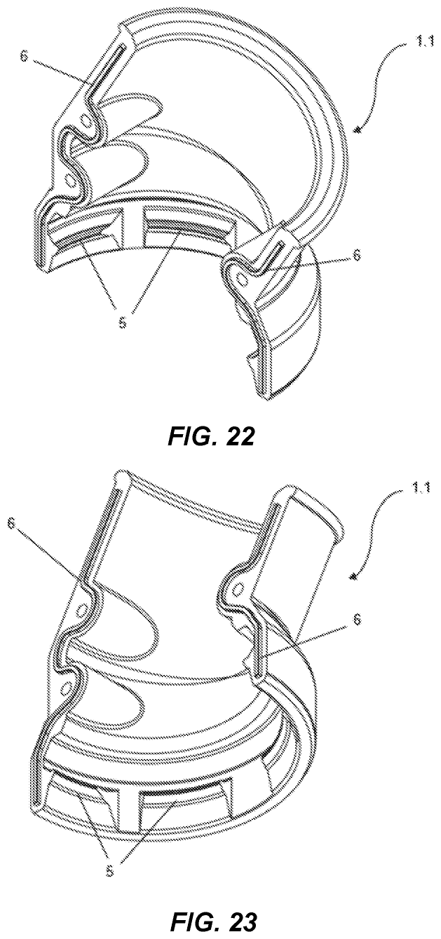

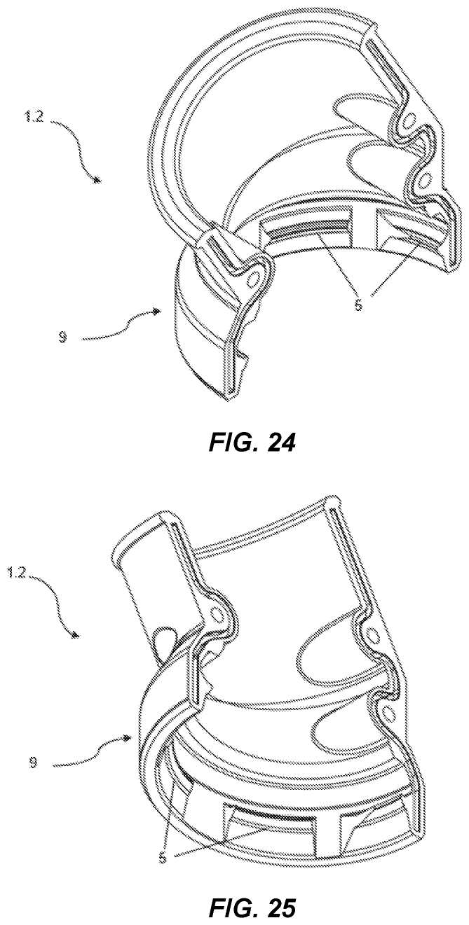

The split nozzle 1, illustrated in FIG. 6 and in more detail in FIGS. 16 to 25, may be assembled by fastening the first and second portions 1.1, 1.2 to each other, such as utilizing fittings and screws 12. In this embodiment, the body of the split nozzle 1 can be made of a single, rigid material. The split nozzle 1 may also allow for mounting to the tubular opening 3 by joining the first and second portions 1.1, 1.2 of the nozzle 1 with a locking mechanism 5 (FIG. 7) of the nozzle 1 over locking tabs 4 of the tubular opening 3. As shown in FIGS. 6 and 7, the locking tabs 4 may protrude outward from the tubular opening 3 and the locking mechanism 5 of the nozzle 1 may protrude from a sidewall of the nozzle 1 inward. In other embodiments, a lower portion of the nozzle 1 may fit within the tubular opening 3. In this case, the locking tabs 4 may protrude inward relative to the tubular opening 3 and the locking mechanism 5 may protrude from the sidewall of the nozzle 1 outward.

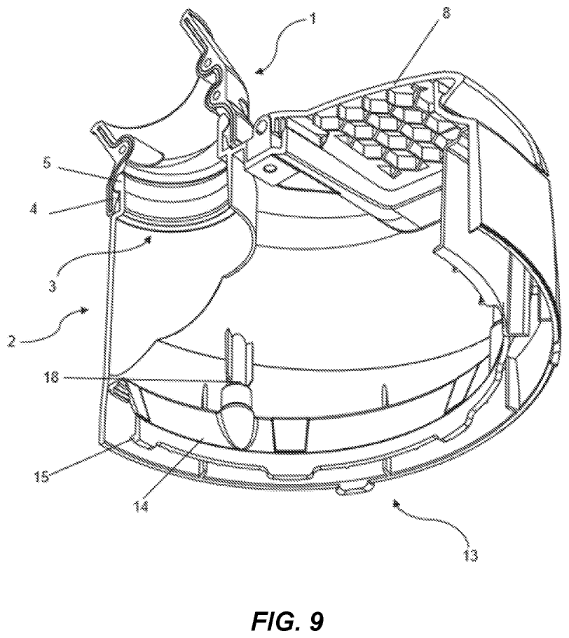

FIGS. 7, 8, and 9 show side sectional views of an assembly, according to some embodiments of the present disclosure. In the views of FIGS. 7, 8, and 9, the coupling details between the nozzle 1 and the tubular opening 3 of the meter input housing 2 and the coupling ring 14 can be seen.

A coupling ring 14 may be a fastener between the meter 10 and the body of the meter input housing 2. The fastener of the meter input housing 2 to the meter 10 may be accomplished by fastening elements 15 disposed at a lower (from the perspective of FIGS. 7, 8, and 9) edge of the coupling ring 14.

In one example, the fastening elements 15 may include quick-release locks that serve to facilitate coupling of the meter input housing 2 to the meter 10. In this example, coupling the meter input housing 2 to the meter 10 may be accomplished by simply pressing the meter input housing 2 against the meter 10. In addition or alternatively, screws may be included to assist fixing the meter input housing 2 to the meter 10 and to increase the decoupling resistance.

Attachment of the coupling ring 14 to the meter input housing 2 may be accomplished by at least one fastener 18 (e.g., a movable lock, a quick coupler, a screw fitting, etc.). In a non-limiting embodiment, the fastener 18 may include tower fittings as shown in FIGS. 7 and 8, which may be configured to receive internal screws for securing the coupling ring 14 to the meter input housing 2.

In some embodiments of the present disclosure, a seal element 6 may used between the portions 1.1, 1.2 of the split nozzle 1. The seal element 6, in addition to sealing the nozzle 1 to inhibit unwanted material (e.g., water, dirt) from entering the nozzle 1, may also assist in fitting and may improve a clamping effect. The seal element 6 may be or include one or more seals, gaskets, rubber, metallic mechanical seals, and/or interference fittings of the material of the nozzle 1 itself.

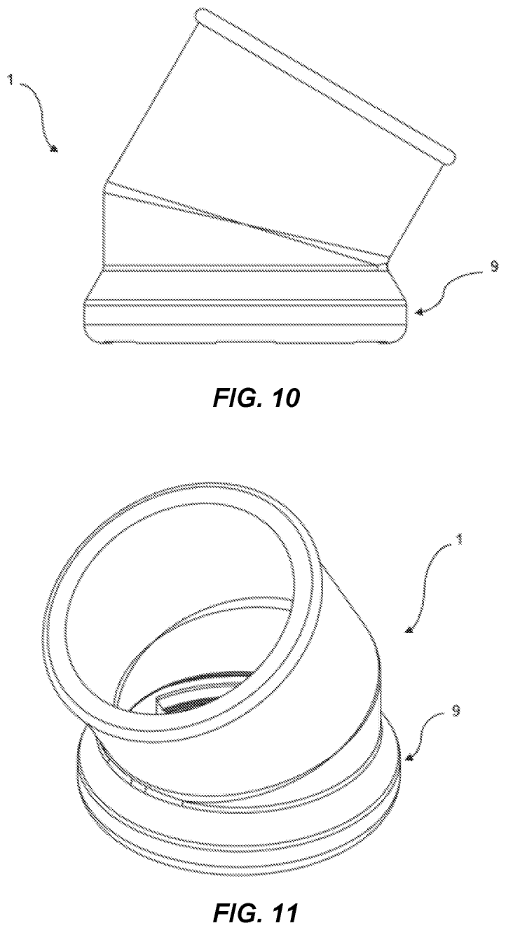

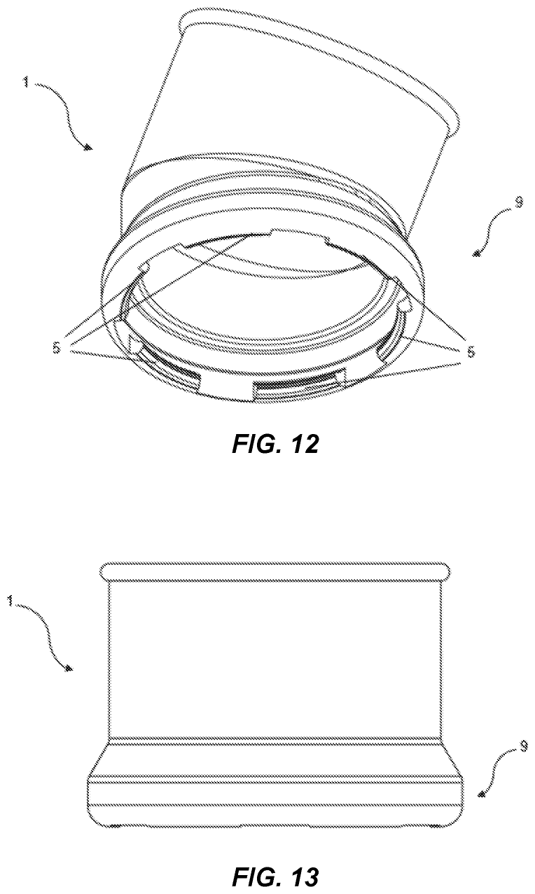

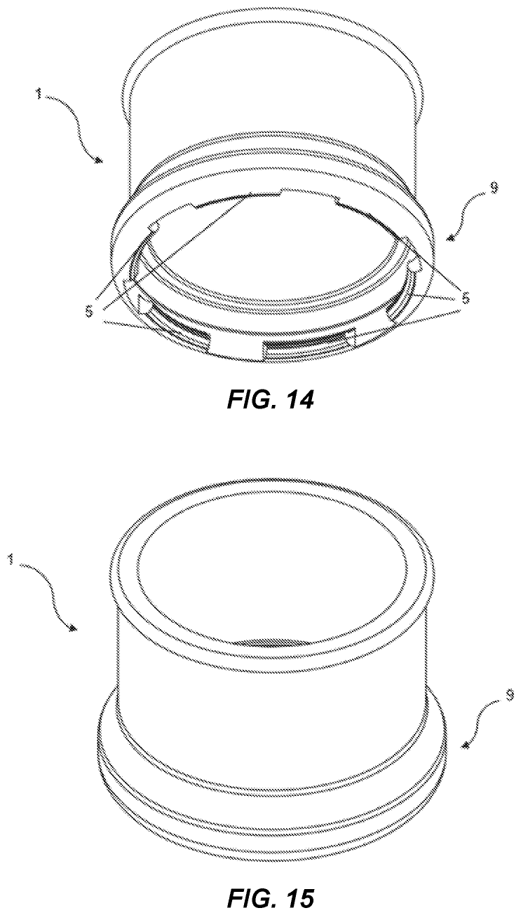

Alternatively to the split form of the nozzle 1 as described above, examples of the present disclosure also include a single body nozzle 1, mm as shown in FIGS. 10 to 12 in a slanted configuration and FIGS. 13 to 15 in a straight configuration

In embodiments in which the nozzle 1 has a single, unitary body, the nozzle 1 may include at least a locking region 9 that may be made of resilient material designed to allow the nozzle 1 to be snap-fitted to the tubular opening 3 of the meter input housing 2. In such embodiments, the material of the locking region 9 may be sufficiently malleable to allow the nozzle 1 to fit into the tubular opening 3, but to maintain sufficient rigidity so that the nozzle 1 does not easily come loose from the tubular opening 3 during operation of the implement.

In the embodiment illustrated in FIGS. 10 to 12, the nozzle 1 is angled to facilitate the fitting of the hose 17 to the central box 16, which may not be positioned exactly above the meters but further back toward the front of the agricultural implement. This inclined configuration, together with the 360° freedom of rotation (e.g., a fully rotatable state) of the nozzle 1 around the tubular opening 3, further contributes to the hose 17 being bendable without causing chokes that might otherwise block the passage of inputs when the central box 16 is in the down position.

In another embodiment of the present disclosure, illustrated in FIGS. 13 to 15, the nozzle may be straight but still exhibits a 360° freedom of rotation of around the tubular opening 3 of the meter input housing 2. As shown in these FIGS., the straight configuration is illustrated only in one piece, but the split configuration may also be applied to the straight nozzle 1.

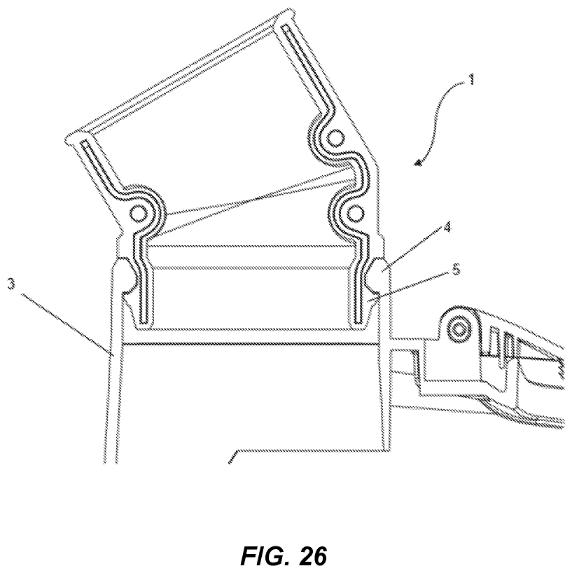

Another example for joining the nozzle 1 to the tubular opening 3 is illustrated in FIG. 26, in which the locking mechanism 5 of the nozzle 1 is inserted into the tubular opening 3. In this example, the locking mechanism 5 may protrude outward while the locking tabs 4 of the tubular opening 3 may protrude inward. This configuration may provide greater internal insulation from the input flow in the contact region between the locking tabs 4 of the tubular opening 3 and the locking mechanism 5 of the nozzle 1.

Although the present disclosure has been specifically described with respect to particular embodiments, it should be understood that variations and modifications will be apparent to those skilled in the art and may be made without departing from the scope of protection of the present disclosure. Accordingly, the scope of protection is not limited to the embodiments described, but is limited only by the appended claims, the scope of which must include all equivalents.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An agricultural implement nozzle assembly, comprising:
a meter input housing including a tubular opening;
a locking tab protruding from a peripheral region of the tubular opening; and
a tubular nozzle including a locking mechanism complementary to the locking tab protruding from the peripheral region of the tubular opening,
wherein the nozzle is rotatable relative to the tubular opening when the nozzle is coupled to the meter input housing via the locking mechanism and the locking tab.

2. The agricultural implement nozzle assembly of claim 1, wherein the locking tab protrudes inward in the tubular opening and the locking mechanism protrudes outward from the nozzle.

3. The agricultural implement nozzle assembly of claim 1, wherein the locking tab protrudes outward from the tubular opening and the locking mechanism protrudes inward from the nozzle.

4. The agricultural implement nozzle assembly of claim 1, further comprising a seal element positioned to inhibit unwanted material from entering the nozzle.

5. The agricultural implement nozzle assembly of claim 1, wherein the locking mechanism of the nozzle is movable relative to a sidewall of the nozzle.

6. The agricultural implement nozzle assembly of claim 1, wherein the nozzle is a split nozzle comprising a first portion and a second portion configured to be assembled to each other.

7. The agricultural implement nozzle assembly of claim 6, further comprising a quick-fit mechanism configured to join the first portion and the second portion.

8. The agricultural implement nozzle assembly of claim 6, further comprising at least one screw to join the first portion and the second portion.

9. The agricultural implement nozzle assembly of claim 1, wherein at least the locking mechanism comprises a resilient material that is configured to flex to snap-fit the nozzle to the tubular opening of the meter input housing.

10. The agricultural implement nozzle assembly of claim 1, wherein the nozzle is fully rotatable with respect to the tubular opening.

11. The agricultural implement nozzle assembly of claim 1, wherein the meter input housing comprises a reservoir for at least one of: seeds, fertilizer, graphite, or inoculant.

12. An agricultural implement input assembly, comprising:
an input meter having an upper input receiving aperture;
an input housing configured to be coupled to the input meter, the input housing comprising:
a tubular opening for feeding an input into the input housing;
an inspection opening covered by an inspection cap; and
a lower coupling opening sized and shaped to direct the input into the upper input receiving aperture of the input meter; and
a coupling ring configured to couple the input housing to the input meter.

13. The agricultural implement input assembly of claim 12, wherein the coupling ring comprises at least one fastener for securing the coupling ring to the input meter.

14. The agricultural implement input assembly of claim 13, wherein the at least one fastener comprises at least one of: a movable lock, a quick coupler, or a screw fitting.

15. The agricultural implement input assembly of claim 12, wherein the meter input housing comprises a reservoir for seeds, fertilizer, graphite, or inoculant.
